(19) United States
(12) Patent Application Publication
(10) Pub. No.: US 2018/0244890 A1
(43) Pub. Date: Aug. 30, 2018

(54) THERMALLY CONDUCTIVE COMPOSITES

(71) Applicant: PHILIPS LIGHTING HOLDING B.V., EINDHOVEN (NL)

(72) Inventors: Rifat Ata Mustafa HIKMET, EINDHOVEN (NL); Paulus Albertus VAN HAL, EINDHOVEN (NL)

(21) Appl. No.: 15/553,480

(22) PCT Filed: Feb. 12, 2016
(86) PCT No.: PCT/EP2016/053023

§ 371 Date: Aug. 24, 2017

(30) Foreign Application Priority Data
Feb. 26, 2015 (EP) 15156648.6

(51) Int. Cl. C08K 3/04; C08J 3/09; C08K 3/38; D01F 1/10; B29C 64/118; B33Y 70/00; B33Y 10/00; D01F 6/04

(52) U.S. Cl. CPC C08K 3/04; C08J 3/092; C08K 3/38; D01F 1/10; B29C 64/118; B29K 2509/04; B33Y 10/00; D01F 6/04; C08J 2323/06; C08K 2003/385; B33Y 70/00

(57) ABSTRACT

The present invention relates to thermally conductive composite materials comprising an ultrahigh molecular weight (UHMW) polymer and a filler material in an amount of greater than about 60 wt % and uses thereof, including in fused deposition modeling and 3-D printing for making articles. The invention also relates to making the composite materials in solution. The composite materials possess desirable thermal conductivity and at least acceptable physical and/or mechanical properties.

### FIELD OF THE INVENTION

The invention relates to thermally conductive composite materials comprising an ultrahigh molecular weight (UHMW) polymer and a filler material and methods of making the composite materials. The invention also relates to the use of the composite materials for making articles. The invention further relates to compositions formed in the method and their use in various applications including in making the composite materials and the use of said compositions and composite materials in fused deposition modeling and 3-D printing.

### BACKGROUND OF THE INVENTION

There is a need for materials with high thermal conductivity which may be processed in a straight-forward manner. These materials can be used in applications such as heat sinks and heat pipes. For these purposes, polymeric materials combined with heat conductive fillers can be used. However, in order to obtain high thermal conductivity it may be necessary to load the polymeric materials with high levels of filler material. Hitherto, it has proved difficult to achieve high filler loadings. One problem associated with high filling levels is that the mechanical and/or physical properties of the filled material may be compromised or adversely affected, for example the brittleness of the resulting composite material may increase to potentially unacceptable levels.

Combining UHMW polymers such as UHMW polyethylene (UHMW-PE) with filler materials has been suggested. However, such UHMW polymers tend to be difficult to process from the melt and using conventional methods. In manufacturing UHMW-PE based components, due to the high melt viscosity of UHMW-PE, conventional processing techniques such as injection moulding, screw extrusion and blow moulding tend not to be suitable. Due to the high viscosity of UHMW-PE, the polymer tends to swell instead of melt. Methods for processing UHMW-PE in solution have been suggested. For example Bin et al in Polymer Journal, Vol. 39, No 6, pp 598-609 (2007) disclose the preparation of UHMW-PE and multi-wall carbon nanotube (MWNT) composites using either decalin or paraffin as a solvent. However, the loading levels of MWNT reported in Bin et al are low. Also, the filler material is limited to the use of multi-wall carbon nanotubes.

Hence, there is still a need for alternative and/or improved materials and methods of preparing materials which possess high thermal conductivity and, optionally, at the same time possess at least acceptable other properties such as physical and/or mechanical properties. It would also be desirable if said materials were suitable for use in fused deposition modeling and 3-D printing techniques.

### SUMMARY OF THE INVENTION

It is an object of the present invention to overcome these problems, and, inter alia, to provide a thermally conductive composite material and a method of preparing the composite material. It would be advantageous to achieve high levels of thermal conductivity and, optionally, acceptable or improved physical properties such as low density and/or acceptable or improved mechanical properties such as low levels of brittleness.

According to a first aspect of the invention, these and other objects may be achieved by a method of preparing a composite material comprising:

(a) forming a composition comprising a solvent, an ultrahigh molecular weight polymer and a filler material;
(b) removing the solvent to form said composite material;
wherein the filler material is present in the composite material in an amount of greater than about 60 wt %.

In a second aspect, the invention provides a composite material comprising an ultrahigh molecular weight polymer and a filler material wherein the filler material is present in the composite material in an amount of greater than about 60 wt %, for example greater than about 90 wt %. The composite material in accordance with the second aspect of the invention may be obtained or may be obtainable from the method in accordance with the first aspect of the invention.

The composition formed in (a) of the first aspect of the invention represents a further aspect of the present invention. Accordingly, in a third aspect, the invention provides a composition for use in step (a) comprising a solvent, an ultrahigh molecular weight polymer and a filler material, wherein the filler material is present in an amount to form a composite material comprising greater than about 60 wt % of said filler material. In the composition formed in (a), the ultrahigh molecular weight polymer is dissolved in the solvent to form a solution thereof. The filler material may be insoluble, partially soluble or fully soluble in the solvent. The addition or presence of the filler material may form a suspension. In order to dissolve the UHMW polymer in the solvent, the composition or the solvent may be heated. For example, the composition or solvent may be heated to greater than about 150° C. In the method aspects of the invention, the UHMW polymer may be added to the solvent and/or the solvent may be added to the polymer to form a solution thereof.

The inventors have surprisingly found that high levels of filler material (greater than about 60 wt %) may be incorporated into a composite material comprising an ultrahigh molecular weight polymer by preparing the composite material via a method wherein the UHMW polymer and, optionally, the filler material, are in solution. The presence of the filler material may give rise to a suspension. The resulting composite material possesses a desirable conductivity and, optionally, at least acceptable mechanical and/or physical properties, for example at least acceptable levels of brittleness and/or low density. The resulting composite material is also suited for forming filaments and for use in 3-D printing and FDM.

By the term “ultrahigh molecular weight polymer”, is herein meant a polymer having a weight average molecular weight from about 500,000 to about 10,000,000. The polymer may be a thermoplastic polymer.

By the term “composite material” is herein meant a material which is made from two or more constituent materials with different physical and/or chemical properties, that when combined produce a material with physical and/or chemical characteristics different from the individual components. The individual components remain separate and distinct within the composite material.

An advantage of the method according to the present invention is that it is suitable for producing flexible composite materials which possess desirable thermal conductivity, for example in plane and/or perpendicular thermal conductivity, with high filler loadings. The composite materials made in accordance with the present invention may also typically possess desirable porosity, density and weight.

In further aspects, the invention provides an article, e.g. a solid article, formed from the method or from the composite material or from the composition in accordance with the first, second and third aspects of the present invention respectively. Suitable articles include heat sinks and heat pipes. The article may consist of or comprise the composite material. The composite material, the method for forming the composite material and the composition in accordance with the present invention are suitable for incorporating in a 3-D printing process and in fused deposition modeling (FDM) processes. The composite material in accordance with the present invention may be formed into or provided in the form of a solid filament. The solid filament may be used in FDM or 3-D printing processes to form articles. The article may be in the form of a mould. The composite material, which may be in the form of a filament, may be melted, extruded and optionally laminated in a 3-D printing process or an FDM process in accordance with the present invention. The article may be a laminated structure.

In yet further aspects of the invention, the presence or amount of the filler material may be expressed in terms of vol %. Therefore, there is provided, a method of preparing a composite material comprising:

(a) forming a composition comprising a solvent, an ultrahigh molecular weight polymer and a filler material;
(b) removing the solvent to form said composite material;
wherein the filler material is present in the composite material in an amount of greater than about 30 vol %.

The invention also provides a composite material comprising an ultrahigh molecular weight polymer and a filler material wherein the filler material is present in the composite material in an amount of greater than about 30 vol %. The composite material may be obtained or may be obtainable from the method in accordance with the invention.

The invention also provides a composition for use in step (a) comprising a solvent, an ultrahigh molecular weight polymer and a filler material, wherein the filler material is present in an amount to form a composite material comprising greater than about 30 vol % of said filler material.

In the method aspects of the invention, the composition may consist of, or consist essentially of, the filler material and the solution of ultrahigh molecular weight polymer.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a composite material in accordance with the present invention being used in part of an FDM printer to form a three dimensional article.

FIGS. 2a and 2b show articles made according to the present invention prepared using a FDM technique.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person. Like reference numerals in the drawings refer to like elements throughout.

The present inventors have found that high levels of filler material, for example greater than about 60 wt %, or for example greater than about 30 vol %, may be incorporated into a composite material comprising an ultrahigh molecular weight polymer. The composite material possesses a desirable conductivity and, optionally, at least acceptable mechanical and/or physical properties, for example at least acceptable levels of brittleness and/or density.

In examples of the invention, the filler material, which may be in the form of a particulate filler material, may be of any suitable material to increase the thermal conductivity of the ultrahigh molecular weight polymer. For example, the filler material may be selected from one or more of the following: metallic particles, graphite, graphite flakes, boron nitride. The metallic particles may be selected from one or more of aluminum, copper, alloys, for example bronze, metal compounds, for example metal oxides. An example of a suitable metal oxide is aluminum oxide. The filler material may be a unidirectional conductor. The filler material may be selected from one or more ductile metals, for example the filler material may be selected from one or more of tin or copper.

The filler material may be included in amounts of greater than about 60 wt % based on the total weight of the dry components of the composite material. For example, the filler material may be included in amounts of greater than about 70 wt %, such as greater than about 80 wt %, such as greater than about 85 wt %, such as greater than about 90 wt %, such as at least about 95 wt %, all based on the total weight of the dry components of the composite material. The filler material may be included in an amount of up to about 98 wt %, or up to about 95 wt %, based on the total weight of the dry components of the composite material.

The presence of the filler material may be expressed in terms of a vol %. As such, the filler material may be included in amounts of greater than about 30 vol % based on the total volume of the dry components of the composite material. For example, the filler material may be included in amounts of greater than about 35 vol %, such as greater than about 40 vol %, such as greater than about 42 vol %, such as greater than about 45 vol %, such as at least about 47 vol %, all based on the total volume of the dry components of the composite material. The filler material may be included in an amount of up to about 50 vol %, or up to about 47 vol %, based on the total volume of the dry components of the composite material. In embodiments of the invention, the filler material may comprise or consist of graphite, e.g. graphite flakes, in an amount of about 45 vol % to about 50 vol % in a composition comprising ultrahigh molecular weight polymer, for example polyethylene, based on the total volume of the dry components of the composite material.

The filler material may be present in the form of particles in one or more of a range of shapes, for example, fibers, elongated fibers, plate shaped particles, spherical particles, irregular shaped particles. The largest dimension of a given particle may be about 10 μm to about 500 μm.

The ultrahigh molecular weight polymer may be selected from or comprise ultrahigh molecular weight polyethylene, or ultrahigh molecular weight polypropylene, or ultrahigh molecular weight polyacrylate, for example ultrahigh molecular weight polymethylmethacrylate. The polypropylene may be isotactic. The ultrahigh molecular weight polymer has a weight average molecular weight from about 500,000 to about 10,000,000.

The ultrahigh molecular weight polymer may be included in amounts of at least about 2 wt % based on the total weight of the dry components of the composite material. For example, the filler material may be included in amounts of at least about 5 wt %, such as at least about 10 wt %, such as at least about 15 wt %, such as at least about 20 wt %, such as at least about 25 wt %, all based on the total weight of the dry components of the composite material. The ultrahigh molecular weight polymer may be included in an amount of up to about 30 wt %, or up to about 39 wt %, or less than about 40 wt %, based on the total weight of the dry components of the composite material. The ultrahigh molecular weight polymer may be included in an amount so that the total amount of filler and ultrahigh molecular weight polymer is about 100% based on the total weight of the dry components of the composite material.

The solvent is suitable for dissolving the ultrahigh molecular weight polymer for use in the present invention. The ultrahigh molecular weight polymer or polymers may dissolve at least partially or completely in the solvent and form a solution thereof. In order to dissolve the UHMW polymer, the composition in (a) may be heated. The composition in (a) may be stirred. The solvent may be heated before and/or during combination with the UHMW polymer and/or filler material. For example, the solvent may be heated to greater than about 150° C. The composition may be heated to greater than about 150° C. The filler material may dissolve to at least some extent in the solvent but at least some of the filler material may remain in suspension or undissolved. A suitable solvent or solvents may depend on the nature of the ultrahigh molecular weight polymer and to some extent the filler material. The solvent may be a single solvent or comprise more than one solvent. A suitable solvent or solvents for ultrahigh molecular weight polymers may include one or more organic solvents. For example, a suitable solvent or solvents may be selected from one or more non polar solvents. For example, a suitable solvent or solvents may be selected from one or more of decalin, xylene, paraffin oil, naphthalene. The one or more solvents may have a boiling temperature above about 150° C. The solvent may be removed in step (b) by evaporation or extraction. The solvent may be removed in step (b) by applying heat. The composite material may be further dried following removal of the solvent in step (b).

The composite material made in accordance with embodiments of the invention may have a thermal conductivity in plane in the range of from about 2 W/mK to about 100 W/mK. The composite material made in accordance with embodiments of the invention may have a thermal conductivity in plane in the range of from at least about 10 W/mK or from at least about 35 W/mK. The in plane thermal conductivity is measured by pressure induced orientation of the filler in the composite. The composite material made in accordance with embodiments of the invention using graphite fillers may have a thermal conductivity in plane in the range of from about 2 W/mK to about 100 W/mK. The composite material made in accordance with embodiments of the invention using graphite fillers may have a thermal conductivity in plane in the range of from at least about 10 W/mK or from at least about 35 W/mK. The in plane thermal conductivity is measured by pressure induced orientation of graphite platelets in the composite material.

The composite material made in accordance with embodiments of the invention may have a thermal conductivity (perpendicular) in the range of from about 1 W/mK to about 30 W/mK. The composite material made in accordance with embodiments of the invention may have a thermal conductivity (perpendicular) in the range of from at least about 4 W/mK or from at least about 8 W/mK. The composite material made in accordance with embodiments of the invention using graphite may have a thermal conductivity (perpendicular) in the range of from about 1 W/mK to about 30 W/mK. The composite material made in accordance with embodiments of the invention using graphite may have a thermal conductivity (perpendicular) in the range of from at least about 4 W/mK or from at least about 8 W/mK. The thermal conductivity (perpendicular) is measured by pressure oriented samples. Measurements are performed using a thermal conductivity analyzer. This technique comprises the use of a one sided, interfacial, heat reflectance sensor that applies a momentary, constant heat source to the sample. Thermal conductivity and effusivity are measured directly, providing a detailed overview of the thermal characteristics of the sample material.

The composite material made in accordance with embodiments of the invention may possess a porosity in the range of about 5% to about 30% or from about 5% to about 15% or from about 10% to about 25%. The porosity of the composite material is estimated by measuring the mass and volume of the composite material and comparing it with the theoretical density value assuming zero porosity.

The composite material made in accordance with embodiments of the invention may possess a density in the range of about 1 g/cm³ to about 5 g/cm³, for example about 1 g/cm³ to about 2 g/cm³. The composite material made in accordance with embodiments of the invention may possess a density of less than about 5 g/cm³, for example less than about 2 g/cm³. The density of the composite material is measured by measuring the weight and volume of the composite materials and by using the theoretically expected density of the material.

The method, composite material and/or composition described herein in accordance with the various aspects of the present invention may be used in combination with a fused deposition modeling process or a 3-D printing process. The method, composite material and/or composition described herein may be used in a lamination technique for producing articles. Filaments of the composite material obtained in accordance with the present invention may be used to make a laminated structure or article. The solvent may be reduced or removed, for example by evaporation and/or heating, during and/or after the modeling and/or printing process. Reduction and/or removal of the solvent results in the viscosity of the solution increasing. In the fused deposition modeling process a thermoplastic filament may be heated to its melting point and then extruded. The extruded filament may then be deposited layer by layer to create a three dimensional object or article. The object or article may be formed by a lamination technique whereby layers of the extruded filament are pressed together using a heated laminator.

The invention provides a method of preparing a composite material comprising:

(a) forming a composition comprising a solvent, an ultrahigh molecular weight polymer and a filler material wherein at least the ultrahigh molecular weight polymer is dissolved in said solvent to form a solution thereof;
(b) removing the solvent to form said composite material;
wherein the filler material is present in the composite material in an amount of greater than about 60 wt %;
(c) further comprising forming an article comprising or consisting of the composite material and wherein the article is formed in a fused deposition modeling process or a 3-D printing process;
wherein optionally the solvent is selected from one or more of decalin, xylene, paraffin oil, naphthalene and optionally wherein the filler material is selected from one or more of graphite, boron nitride, metallic particles, metallic oxide particles, graphite flakes and optionally wherein the ultrahigh molecular weight polymer is present in an amount of less than about 40 wt % for example up to about 39 wt % and at least about 2 wt % or at least about 5 wt %. The invention also provides a composite material obtainable from said method.

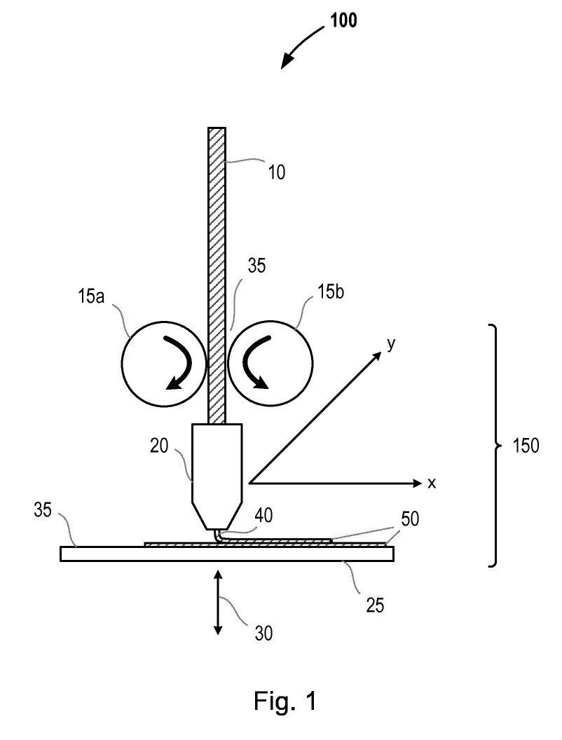

FIG. 1 illustrates an arrangement (100) comprising a filament of composite material (10), (or a composition) in accordance with the present invention being used in part of an FDM printer indicated generally at (150). The FDM printer comprises drive wheels (15a, 15b) shown counter-rotating in relation to each other, a heated print head (20) and a heated platform (25). The heated platform may be raised or lowered as indicated (30). In FIG. 1, a filament of the composite material (10) is shown being fed through a capillary (35) formed by the gap between the two drive wheels (15a and 15b). The drive wheels (15a, 15b) are shown rotating in a clockwise and counter-clockwise motion respectively. The filament of composite material (10) may comprise some solvent in order to assist with the processing. The solvent may be residual solvent from the method in accordance with the present invention for making the composite material and/or the solvent may comprise fresh solvent combined with the composite material. After passing through the drive wheels (15a. 15b) the filament of composite material (10) is guided through a heated print head (20). The filament of composite material (10) is heated as it passes through the print head (20) and typically will be of a reduced thickness or diameter as it is ejected from the heated print head (20) as indicated at (40). The heated filament (40) is deposited on to a heated platform (25), the distance between the heated print head (20) and an upper surface (35) of the heated platform (25) being adjustable, as indicated at (30). The heated printer head (20) may be moved in a variety of directions (indicated by “x” and “y”) relative to the heated platform (25) or vice versa. The direction “y” indicates a direction into the plane of the page and is approximately at right angles to the direction indicated by “x”. Directions other than in the “x” and “y” direction are also possible. A range of articles with a range of shapes may be made in this manner. The deposited composite material (50) comprising a number of layers may be pressed together using a laminator (not shown). The laminator may be heated. The deposited (laminated) material may then be allowed to cool.

The method and the composition in accordance with the present invention may further comprise the use of additive materials. These additional materials may decrease the amount of time taken for printing and/or modeling. Examples of suitable additive materials may be selected from one or more olefins, for example low molecular weight olefins. The olefin may be selected from one or more straight chain olefins, for example one or more C₂-C₁₈ straight chain olefins.

The composite material and the composition in accordance with the present invention is suitable for forming articles. Examples of suitable articles are heat sinks, heat pipes, laminated structures. Prior to forming the articles, the composite material in accordance with the present invention may be in the form of filaments optionally in the presence of residual solvent. For use in a 3-D printing technique or an FDM process, the filament is typically a thermoplastic filament. In embodiments of the present invention, the filler may be provided by one or more ductile metals, for example tin or copper, which may be in the form of particles. Pressure may be applied to the composition or composite material comprising the one or more ductile metals to press them together in the formation of an article.

### EXAMPLES

The inventors investigated the thermal conductivities (in plane and perpendicular) as well as the porosity and density of composite materials comprising UHMW polymers prepared according to embodiments of the inventive method. The inventors also investigated exemplary filler materials and amounts thereof, solvent type and temperature in connection with the formation of composite materials.

In the Examples, the UHMW polyethylene (weight average molecular weight 6,000,000, density 0.95 g/cm³; Hostalen Gur) graphite flake (density 2.16 g/cm³, 10 mesh; Alfa Aesar), boron nitride (density 2.1 g/cm³, Henze, HeBoFill®501).

### Example 1: Preparation of a Filled UHMW-PE with Graphite

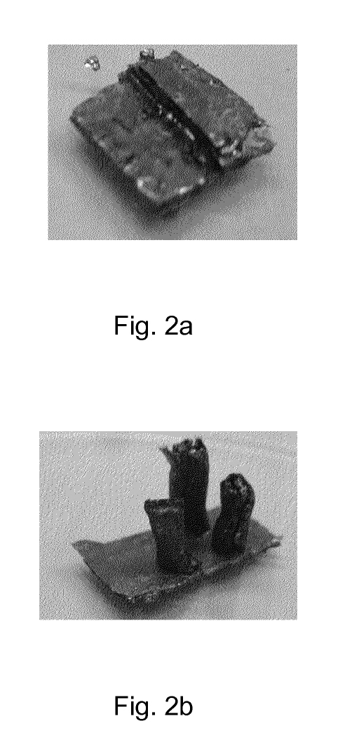

A solution comprising 1 g of UHMW polyethylene (the polymer), 10 g graphite and 89 g Decalin (decahydronaphthalene) was prepared. The polymer was dissolved in the solvent above 150° C. The solution was heated and stirred vigorously. The solution was cooled and the solvent was extracted by evaporation leaving a composite of polymer and graphite. The composite (or filled polymer) comprised 91 wt % of graphite particles and 9 wt % of polymer which corresponds to about 18% by volume of the polymer. The composite material formed in Example 1 was subsequently processed in an FDM printer and the resulting article is shown in FIG. 2a. The composite material was heated to its melting point and extruded between rollers and deposited via a heated print head onto a heated platform. Layers of the deposited composite material were pressed together using a heated laminator.

### Example 2: Preparation of a Filled UHMW-PE with Graphite

A solution comprising 0.5 g of UHMW polyethylene (the polymer), 10 g graphite and 49 g Decalin (decahydronaphthalene) was prepared. The polymer was dissolved in the solvent above 150° C. The solution was heated and stirred vigorously. The solution was cooled and the solvent was extracted by evaporation leaving a composite of polymer and graphite. The composite (or filled polymer) comprised 95 wt % of graphite particles and 5 wt % of polymer which corresponds to about 10% by volume of the polymer.

### Example 3: Preparation of a Filled UHMW-PE with Boron Nitride

A solution comprising 1 g of UHMW polyethylene (the polymer), 10 g boron nitride (BN) and 89 g Decalin (decahydronaphthalene) was prepared. The polymer was dissolved in the solvent above 150° C. The solution was heated and stirred vigorously. The solution was cooled and the solvent was extracted by evaporation leaving a composite of polymer and Boron Nitride. The composite (or filled polymer) comprised 91 wt % of boron nitride and 9 wt % of polymer which corresponds to about 18% by volume of the polymer. The composite material formed in Example 3 was subsequently processed in an FDM printer and the resulting article is shown in FIG. 2b. The composite material was heated to its melting point and extruded between rollers and deposited via a heated print head onto a heated platform. Layers of the deposited composite material were pressed together using a heated laminator.

TABLE 1
Conductivity, porosity and density measurements
in connection with Examples 1-3

| | Thermal | Thermal | | |
|---|---|---|---|---|
| | Conductivity | Conductivity | | |
| | (in plane) | (perpendicular) | Density | Porosity |
| Composite Material | [W/mK] | [W/mK] | [g/cm³] | [%] |
| 91 wt % graphite, | 10 | 4 | 1.5 | 25 |
| 9 wt % UHMW-PE | | | | |
| 95 wt % graphite, | 36 | 8 | 1.9 | 10 |
| 5 wt % UHMW-PE | | | | |
| 91 wt % BN, | 2 | | 1.7 | 15 |
| 9 wt % UHMW-PE | | | | |

From Table 1, it is evident that the thermal conductivities of the composite materials are highly anisotropic and may be tailored by varying the amount of polymer and/or filler in the composite material. In addition, the composite materials are highly porous which gives rise to a reduced density and hence lower weight.

The person skilled in the art realizes that the present invention is by no means limited to the preferred embodiments described above. On the contrary, many modifications and variations are possible within the scope of the appended claims. For example, particles, (e.g. metal particles), possessing isotropic conductivity may be incorporated in the various aspects of the present invention.

Additionally, variations to the disclosed embodiments can be understood and effectuated by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain features are recited in mutually different dependent claims does not indicate that a combination of these features cannot be used to advantage.

For the avoidance of doubt, the present application is directed to the subject-matter described in the following numbered paragraphs:

Paragraph 1. A method of preparing a composite material comprising:

(a) forming a composition comprising a solvent, an ultrahigh molecular weight polymer and a filler material wherein at least the ultrahigh molecular weight polymer is dissolved in said solvent to form a solution thereof;
(b) removing the solvent to form said composite material;

wherein the filler material is present in the composite material in an amount of greater than about 60 wt %.

Paragraph 2. A method according to paragraph 1, wherein in (a) the filler material is present in the form of a suspension.

Paragraph 3. The method according to paragraph 1, wherein the filler material is present in an amount of greater than about 80 wt %.

Paragraph 4. The method according to paragraph 1, wherein the ultrahigh molecular weight polymer is selected from one or more of ultrahigh molecular weight polyethylene, ultrahigh molecular weight polypropylene, ultrahigh molecular weight polyacrylate, ultrahigh molecular weight isotactic polypropylene, ultrahigh molecular weight polymethylmethacrylate.

Paragraph 5. The method according to paragraph 1, wherein the solvent is selected from one or more of decalin, xylene, paraffin oil, naphthalene.

Paragraph 6. The method according to paragraph 1, wherein the filler material is selected from one or more of graphite, boron nitride, metallic particles, metallic oxide particles, graphite flakes.

Paragraph 7. A composite material comprising an ultrahigh molecular weight polymer and a filler material wherein the filler material is present in the composite material in an amount of greater than about 60 wt % or greater than about 80 wt %.

Paragraph 8. The composite material according to paragraph 7, wherein the ultrahigh molecular weight polymer is selected from one or more of ultrahigh molecular weight polyethylene, ultrahigh molecular weight polypropylene, ultrahigh molecular weight polyacrylate, ultrahigh molecular weight isotactic polypropylene, ultrahigh molecular weight polymethylmethacrylate.

Paragraph 9. The composite material according to paragraph 7, wherein the filler material is selected from one or more of graphite, boron nitride, metallic particles, metallic oxide particles, graphite flakes.

Paragraph 10. A composition for use in step (a) of paragraph 1, wherein the filler material is present in an amount to form a composite material comprising greater than about 60 wt % of said filler material.

Paragraph 11. The composition according to paragraph 10, wherein the ultrahigh molecular weight polymer is selected from one or more of ultrahigh molecular weight polyethylene, ultrahigh molecular weight polypropylene, ultrahigh molecular weight polyacrylate, ultrahigh molecular weight isotactic polypropylene, ultrahigh molecular weight polymethylmethacrylate, the filler material is selected from one or more of graphite, boron nitride, metallic particles, metallic oxide particles, graphite flakes, the solvent is selected from one or more of decalin, xylene, paraffin oil, naphthalene and wherein the filler material is present in an amount to form a composite material comprising greater than about 80 wt % of said filler material.

Paragraph 12. The method according to paragraph 1, further comprising forming a filament or an article.

Paragraph 13. The method according to paragraph 1, further comprising forming an article comprising or consisting of the composite material and wherein the article is formed in a fused deposition modeling process or a 3-D printing process.

Paragraph 14. An article formed from or comprising a composite material according to paragraph 7.

Paragraph 15. The article according to paragraph 14, wherein the article is a laminated structure.

1. A method of preparing an article or filament having a composite material, the method comprising:
(a) forming a composition comprising a solvent, an ultrahigh molecular weight polymer and a filler material wherein at least the ultrahigh molecular weight polymer is dissolved in said solvent to form a solution thereof; and
wherein the filler material is selected from one or more of graphite, boron nitride, metallic particles, metallic oxide particles, and graphite flakes; and
wherein the solvent includes one or more of decalin, xylene, paraffin oil, and naphthalene;
(b) removing the solvent to form said composite material;
wherein the filler material is present in the composite material in an amount of greater than 60 wt %; wherein the ultrahigh molecular weight polymer is present in an amount of at least 2 wt %; and
(c) forming the article or filament in a fused deposition modeling process or a 3-D printing process.
wherein the ultrahigh molecular weight polymer is selected from one or more of ultrahigh molecular weight polyethylene, ultrahigh molecular weight polypropylene, ultrahigh molecular weight polyacrylate, ultrahigh molecular weight isotactic polypropylene, and ultrahigh molecular weight polymethylmethacrylate.

2. A method according to claim 1, wherein, in (a), the filler material is present in the form of a suspension.

3. The method according to claim 1, wherein the filler material is present in an amount of greater than 80 wt % or greater than 90 wt %.

4. (canceled)

5. The method according to claim 1, wherein the solvent includes one or more organic solvents.

6. (canceled)

7. (canceled)

8. The method according to claim 1, wherein the ultrahigh molecular weight polymer is present in an amount of less than 40 wt % for example up to 39 wt % and at least 2 wt % or at least 5 wt %.

9. The method according to claim 1, wherein the composition consists of, or consists essentially of, the filler material and the solution of ultrahigh molecular weight polymer.

10. A composite material for use in a fused deposition modeling process or a 3-D printing process; said composite material comprising an ultrahigh molecular weight polymer and a filler material, wherein the filler material is present in the composite material in an amount of greater than 90 wt %; and wherein the filler material is suited to increase the thermal conductivity of the ultrahigh molecular weight polymer; and wherein the composite material is in the form of a filament;
wherein the ultrahigh molecular weight polymer is selected from one or more of ultrahigh molecular weight polyethylene, ultrahigh molecular weight polypropylene, ultrahigh molecular weight polyacrylate, ultrahigh molecular weight isotactic polypropylene, and ultrahigh molecular weight polymethylmethacrylate;
wherein the filler material is selected from one or more of graphite, boron nitride, metallic particles, metallic oxide particles, and graphite flakes; and
wherein the ultrahigh molecular weight polymer is present in an amount of at least 2 wt %.

11. (canceled)

12. (canceled)

13. A filament for use in a fused deposition modeling process or a 3-D printing process comprising a composite material;
wherein the composite material comprises an ultrahigh molecular weight polymer and a filler material, wherein the filler material is present in the composite material in an amount of greater than 90 wt %; and
wherein the filler material is selected from one or more of graphite, boron nitride, metallic particles, metallic oxide particles, and graphite flakes; and
wherein the ultrahigh molecular weight polymer is selected from one or more of ultrahigh molecular weight polyethylene, ultrahigh molecular weight polypropylene, ultrahigh molecular weight polyacrylate, ultrahigh molecular weight isotactic polypropylene, and ultrahigh molecular weight polymethylmethacrylate;
wherein the ultrahigh molecular weight polymer is present in an amount of at least 2 wt %.

14. An article formed from or comprising the filament according to claim 13.

15. The article according to claim 14, wherein the article is a laminated structure.
